(19) United States
(12) Patent Application Publication
(10) Pub. No.: US 2007/0204230 A1
(43) Pub. Date: Aug. 30, 2007

(54) System and method for managing operator replaceable components

(75) Inventors: Richard R.T. Carling, Webster, NY (US); Todd C. Otremba, Hilton, NY (US)

Correspondence Address: Mark G. Bocchetti, Patent Legal Staff,;East Kodak Company, 343 State Street, Rochester, NY, 14650-2201, US

(73) Assignee: Eastman Kodak Company

(21) Appl. No.: 11/362,907

(22) Filed: Feb. 27, 2006

(51) Int. Cl. G06F 13/10

(52) U.S. Cl. 715/733; 703/21

(57) ABSTRACT

A system and a method for managing operator replaceable components (“ORCs”) of a complex device is provided, which may be implemented in the form of a user interface. The user interface may allow selection of one of a plurality of groups of ORCs and may display the individual ORCs in a selected group of the plurality of groups of ORCs. The plurality of groups of ORCs may include at least one of a group of ORCs associated with a particular user access level, a group of ORCs associated with a similar location in the complex device, and a group of ORCs having related maintenance requirements.

### FIELD OF THE INVENTION

This invention relates to managing operator replaceable components. In particular, this invention pertains to providing a user interface that allows a user to efficiently manage operator replaceable components of complex devices, such as commercial printing presses, by grouping via a user interface the operator replaceable components by location, by user access level, and/or by similar maintenance requirements.

### BACKGROUND OF THE INVENTION

Complex devices, such as commercial printing presses, often include a large number of operator replaceable components (“ORCs”) that may be replaced by operators without the assistance of a trained service technician, thereby reducing service and maintenance costs. Conventionally, operators have been provided with spreadsheets that provide information regarding the remaining usable life of the ORCs within their device(s). These spreadsheets typically include the name of the ORCs in a device, as well as the estimated remaining useful life of each of the ORCs in the device. When an ORC nears the end of its estimated remaining useful life, an operator replaces, fixes, or otherwise performs maintenance on (collectively referred to herein as “maintains” or “maintenance”) such component and then updates the spreadsheet accordingly. Because such conventional ORC managing systems have been rudimentary and cumbersome to use, operators have not been inclined to regularly use these systems. Consequently, the conventional spreadsheets often have out-of-date information. In the event that a device needs to be serviced by a trained service technician, the information in the ORC spreadsheet is useless to the technician, or even worse, is misleading to the technician, thereby hindering the service process and increasing costs. Accordingly, a need in the art exists for a simple, effective, and user friendly. solution that allows operators to manage the ORCs in complex devices, so that such operators will be inclined to manage their ORCs and trained service technicians will have accurate ORC information to rely upon when performing device service.

### SUMMARY OF THE INVENTION

The above-described problems are addressed and a technical solution is achieved in the art by a system and a method for managing ORCs according to the present invention. In an embodiment of the present invention, a user interface is provided that is configured to facilitate the management of ORCs. In one embodiment, the user interface allows selection of one of a plurality of groups of ORCs and displays the individual ORCs in a selected group of the plurality of groups of ORCs. The plurality of groups of ORCs may include at least one of a group of ORCs associated with a similar location in the device, a group of ORCs having related maintenance requirements, and a group of ORCs associated with a particular user access level.

By grouping ORCs by location within the device, labor involved in replacing an ORC, or a set of ORCs, may be optimized such that ORCs in the same area may be maintained at the same time as an adjacent ORC. For example, if an inexpensive ORC is in a very difficult to reach location within the device, and a nearby ORC has failed, the user interface may indicate to the operator that both components should be maintained simultaneously.

An advantage of grouping ORCs by similar maintenance requirements is that some ORCs should be maintained any time another ORC has failed. For example, if two parts typically run out of estimated remaining useful life at about the same time, it may be efficient to maintain both of them when one of them fails. In addition, if performance of one part is dependent upon performance of another part, it may be useful to maintain both of them simultaneously, regardless of the estimated remaining useful life of the component that has not yet failed.

By grouping ORCs according to user access levels, operators that do not have much experience in replacing ORCs can be limited to the maintenance of ORCs that are simple to maintain. Operators that have more experience in replacing ORCs may be allowed to maintain a larger set of ORCs than a user at a lower skill level. A trained service technician may be allowed to maintain. any of the ORCs.

By grouping ORCs according to the various embodiments of the present invention, a simple, efficient, and user-friendly interface is provided, thereby increasing the incentive that operators have in maintaining an accurate history of the modifications they have made to the ORCs. Consequently, trained service technicians have accurate information to rely upon when performing device service, thereby reducing service costs.

According to another embodiment of the present invention, the user interface sorts ORCs within a group of ORCs by the ORC's estimated remaining useful life. The estimated remaining useful life may be indicated for each of the ORCs with a color indicator that exhibits different colors depending upon the amount of estimated remaining useful life of an ORC.

According to yet another embodiment of the present invention, when a user selects a particular ORC for maintenance, the user is presented with subcomponents that belong to the selected ORC. The operator then may indicate which of the subcomponents are being maintained. Additionally, the user may be prompted for a reason why a subcomponent of an ORC or an entire ORC is being maintained, and the user interface keeps track of such reasons. These reasons are useful to trained service technicians and device manufacturers.

According to still yet another embodiment of the present invention, selection of an ORC or subcomponent for maintenance leads to the presentation to the operator of instructions on how to. maintain such ORC or subcomponent.

According to another embodiment of the present invention, the user interface keeps track of ORCs that have been swapped out of the device and indicates to the operator which ORCs are currently swapped into and/or out of the device.

The various embodiments of the. present invention may be implemented by computer executable instructions stored on or in one or more computer-accessible memories.

### BRIEF DESCRIPTION OF THE DRAWINGS

The present invention will be more readily understood from the detailed description of exemplary embodiments presented below considered in conjunction with the attached drawings, of which:

FIG. 1 illustrates a system for managing ORCs, according to an embodiment of the present invention;

FIG. 2 illustrates several aspects of a user interface, according to an embodiment of the present invention;

FIG. 3 illustrates several additional aspects of the user interface, according to an embodiment of the present invention;

FIG. 4 illustrates a portion of the user interface showing swappable ORCs, according to an embodiment of the present invention;

FIG. 5 illustrates a portion of the user interface pertaining to user access levels, according to an embodiment of the present invention; and

FIG. 6 illustrates a portion of the user interface pertaining to maintenance of an ORC, according to an embodiment of the present invention.

It is to be understood that the attached drawings are for purposes of illustrating the concepts of the invention and may not be to scale.

### DETAILED DESCRIPTION

The present invention provides a system and a method for managing ORCs. An exemplary vehicle by which the present invention and its embodiments are described herein, involves a user interface configured to facilitate the management of ORCs. However, one skilled in the art will appreciate that the present invention is not limited to the user interfaces described herein, and that the invention includes within its scope the underlying processes that support such user interfaces. Implementation of such underlying processes will be readily apparent to one of ordinary skill in the art by way of the following descriptions and the figures.

The present invention provides the operators of complex devices, not just commercial printing presses as commonly described herein, with a simple, straight-forward, and effective technique for managing the ORCs within such complex device. The easier the system and process for managing ORCs is, the more likely it is that operators will properly maintain such complex devices, thereby reducing the need for trained service technicians and reducing service frequency and costs. Further, if operators keep the information in their ORC managing system up-to-date, trained service technicians will have accurate information when performing service on the complex devices, also thereby reducing service costs.

The descriptions herein use the terms “maintain,” “maintenance,” and “replace” to refer to acts including replacing, fixing, and otherwise performing maintenance on an ORC.

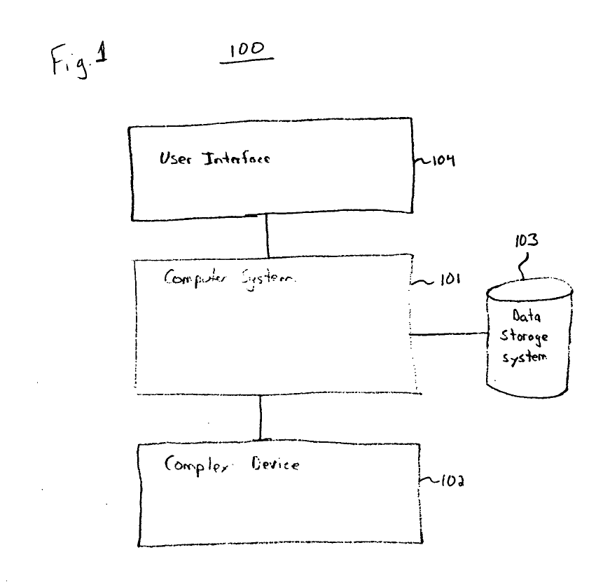

The data processing techniques described herein, according to an embodiment of the present invention, are implemented by a computer system 101 shown in FIG. 1. The computer system 101, part of a more general system 100, may include one or more computers at least some of which are communicatively connected. The computer system 101 is communicatively connected to a complex device 102, which may be a commercial printing press. One skilled in the art will appreciate, however, that the present invention is not limited to commercial printing presses, and applies to any device that has operator replaceable components. Although shown as communicatively connected, the computer system 101 may operate independently of the complex device 102.

The computer system 101 also is communicatively connected to a data storage system 103 and a user interface 104. Although shown separately, the user interface 104 may be included as part of the computer system 101. The user interface 104 may include a display device, a plurality of display devices (i.e. a “display system”), a computer-accessible memory, one or more display devices and a computer-accessible memory, or any device or combination of devices to which data is output by the computer system 101. The user interface 104 also includes a selection mechanism, such as a mouse, a pointer, or a touch-pad; a keyboard; a selection mechanism and a keyboard; or any device or combination of devices from which data is input to the computer system 101.

The-data storage system 103 includes one or more computer-accessible memories. The data storage system 104 may be a distributed data-storage system including multiple computer-accessible memories communicatively connected via a plurality of computers and/or devices. On the other hand, the data storage system 103 need not be a distributed data-storage system and, consequently, may include one or more computer-accessible memories located within a single computer or device.

The term “computer” is intended to include any data processing device, such as a desktop computer, a laptop computer, a mainframe computer, a personal digital assistant, a Blackberry, and/or any other device for processing data, and/or managing data, and/or handling data, whether implemented with electrical and/or magnetic and/or optical and/or biological components, and/or otherwise.

The phrase “computer-accessible memory” is intended to include any computer-accessible data storage device, whether volatile or nonvolatile, electronic, magnetic, optical, or otherwise, including but not limited to, floppy disks, hard disks, Compact Discs, DVDs, flash memories, ROMs, and RAMs.

The phrase “communicatively connected” is intended to include any type of connection, whether wired, wireless, or both, between devices, and/or computers, and/or programs in which data may be communicated. Further, the phrase “communicatively connected” is intended to include a connection between devices and/or programs within a single computer, a connection between devices and/or programs located in different computers, and a connection between devices not located in computers at all. In this regard, although the data storage system 103 is shown separately from the computer system 101, one skilled in the art will appreciate that the data storage system 103 may be stored completely or partially within the computer system 101.

The data storage system 103, according to an embodiment of the present invention, includes an ORC database that identifies the ORCs in the device 102, as well as the estimated remaining useful life of each of the ORCs in such device 102. The ORCs may be identified by unique identifiers. To simplify subsequent processing, the ORC identifiers may be organized into categories and subcategories that may correspond to the groups of ORCs described in more detail below. For example, the ORC identifiers may be organized such that it is simple to determine which groups, described in more detail below, an ORC belongs to. In addition, the subcategories may identify the subcomponents, described in more detail below, that belong to an ORC. The ORC database also may include additional information describing the status and/or characteristics of the ORCs within the device 102. Although the term “database” is used to describe a mechanism for storing and retrieving data identifying the ORCs in the device 102, one skilled in the art will appreciate that any manner of storing and retrieving ORC information described herein may be used.

The data stored in the ORC database is transmitted to the computer system 101, which operates an ORC management system and which transmits ORC information to the user interface 104 for review by an operator or a device. The ORC information transmitted to the user interface 104 by the computer system 101 may include a list of the ORCs in the device 102, as well as the ORCs' estimated remaining useful life and other information. If an ORC nears or has reached the end of its estimated remaining useful life, the computer system 102 may send a notification to the user interface 104 notifying an operator or device that such ORC has neared or reached the end of its estimated remaining useful life. When maintenance has been performed on an ORC, an operator or device informs the computer system 101 via the user interface 104 at least that maintenance has been performed on such ORC. Upon receipt of this information, the computer system 101 updates the ORC database in the data storage system 103 accordingly.

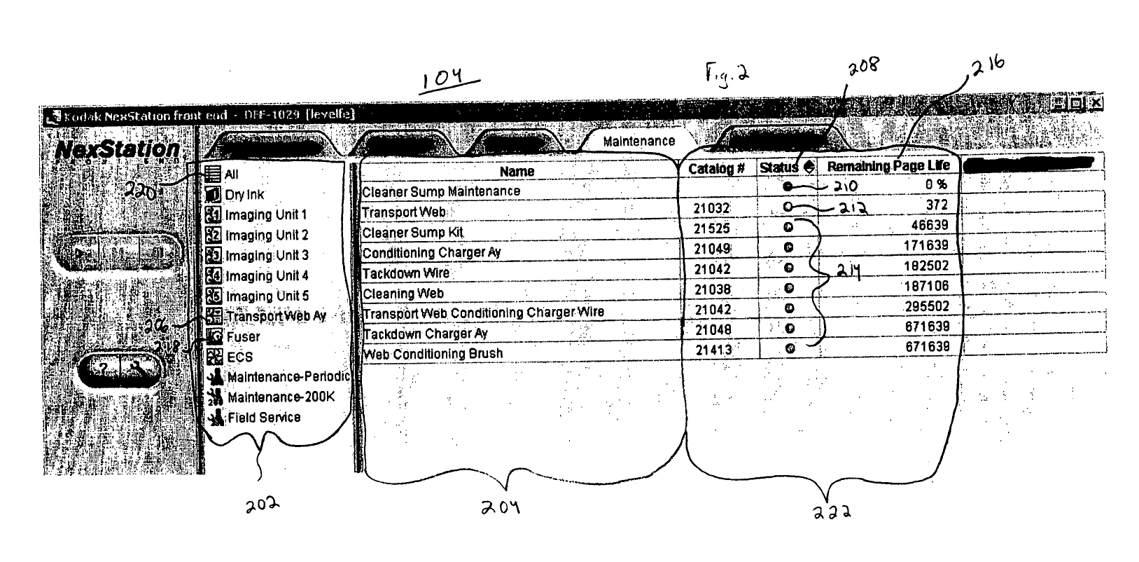

FIG. 2 illustrates data displayed to an operator via the user-interface 104, according to an embodiment of the present invention. The user interface 104, shown in FIG. 2, includes a visual representation 202 of a list of identifiers associated with each of a plurality of groups of ORCs. Although any identification scheme may be used, the embodiment of FIG. 2 has identifiers that include an icon and a name identifying a group of ORCs. For example, the group “Transport Web Ay” is specified by name and by an icon shown at 206 in FIG. 2.

The user interface 104 also includes a visual representation 204 of a list of identifiers each associated with one or more of a plurality of ORCs that belong to a selected group of ORCs. In the embodiment of FIG. 2, an. operator has selected, via the selection mechanism of the user interface 104, the group of ORCs belonging to the transport web 206. Upon selection of the transport web 206, identifiers associated with the ORCs belonging to the transport web 206 of the device 102 are shown in the visual representation 204. In this embodiment, the identifiers are names of the ORCs belonging to the selected group of ORCs. If the operator selects another group of ORCs in the device 102, such as the group of ORCs belonging to the fuser 218 of the device 102, identifiers associated with the ORCs belonging to the fuser 218 are displayed in the visual representation 204. If the operator wants to display identifiers for all of the ORCs in the device 102, the user may select the group “all” 220 via the visual representation 202.

Although the embodiment of FIG. 2 is described in the context of and illustrates lists of identifiers, one skilled in the art will appreciate that the invention is not limited to these particular schemes for conveying information and that any technique for identifying groups of ORCs, the particular ORCs in a group, and other information pertaining to the ORCs may be used. For example, the groups of ORCs, the particular ORCs in a group, and the other information pertaining to the ORCs need not be displayed in a list format, need not be identified by name, may be represented by icons, etc.

The user interface 104 also includes a visual representation 222 of information pertaining to the plurality of ORCs belonging to the selected group of ORCs. This information may include, among other things, another identifier of an ORC, such as a catalog number, and remaining useful life information for one or more of the ORCs identified in the visual representation 204. In the situation that the device 102 is a commercial printing press, the remaining useful life information may include an estimated number of printed pages remain (“Remaining Page Life” 216) before an ORC no longer operates as needed. The remaining useful life information may be calculated according to known techniques.

The information displayed in the visual representation 222 may also include status information for one or more of the ORCs identified in the visual representation 204. The status information may indicate an operating status of an ORC and may depend upon the remaining useful life information. For example, in the embodiment of FIG. 2, the status column 208 includes color-coded indicators 210, 212, and 214 that each show the status of an ORC. If an ORC is at the end of its remaining useful life, a red indicator 210 is shown in the status column 208. If an ORC has little useful life remaining, a yellow indicator 212 is shown in the status column 208. If an ORC has substantial remaining useful life, a green indicator 214 is shown in the status column 208. According to another embodiment of the present invention, the color-coded indicators 210, 212, and 214 may be associated with predetermined percentages of remaining useful life of an ORC. For example, a green-colored indicator may be associated with an ORC that has 10% or more estimated remaining useful life, a yellow-colored indicator may be associated with an ORC having less than 10% estimated remaining useful life, and a red-colored indicator may be associated with an ORC having 0% or less estimated remaining useful life. The predetermined percentages may be different for each ORC. For example, a long-lived ORC may have a yellow indicator exhibited at 5% or less estimated remaining useful life, whereas a short-lived ORC may have a. yellow indicator exhibited at 30% or less estimated remaining useful life. One skilled in the art will appreciate that any type of indication, any number of indicators, number of different colored indicators, and/or any number of predetermined percentages may be used to show status or estimated remaining useful life and that the invention is not limited to the particular indication mechanism discussed with reference to FIG. 2.

The ORC identifiers shown in the visual representation 204 as well as the other pertinent ORC information shown in the visual representation 222 may be sorted by any number of categories. For example, the information in the visual representations 204 and 222 may be sorted by name, catalog number, status, remaining useful life, etc. In the embodiment shown in FIG. 2, the ORCs are sorted by their remaining useful life, which in this case is a remaining page life 216. The ORCs may be sub-sorted, for example, by status of the ORCs shown in the status column 208.

According to various embodiments of the present invention, the user interface 104 groups ORCs based upon, among other things, similar location in the device 102, related maintenance requirements, and user access levels. Grouping ORCs by similar location in the device 102 may be accomplished by providing groups of ORCs shown in the visual representation 202 of FIG. 2 that have such similar locations. For example, the transport web group 206 may include ORCs belonging to a transport web component located in a particular region of the device 102. When an operator needs to maintain an ORC in the transport web component, he or she may want to perform maintenance simultaneously on other ORCs in the transport web to ensure that the transport web component, as a whole, continues to operate as needed. Further, it may be economical or efficient to maintain ORCs in a similar location within the device 102. In particular, labor involved in replacing an ORC, or a set of ORCs, may be optimized such that ORCs in the same area may be maintained at the same time as an adjacent ORC. For example, if an inexpensive ORC is in a very difficult to reach location within the device 102, and a nearby ORC has failed, the user interface according to an embodiment of the present invention, may indicate to the operator that both parts should be maintained simultaneously.

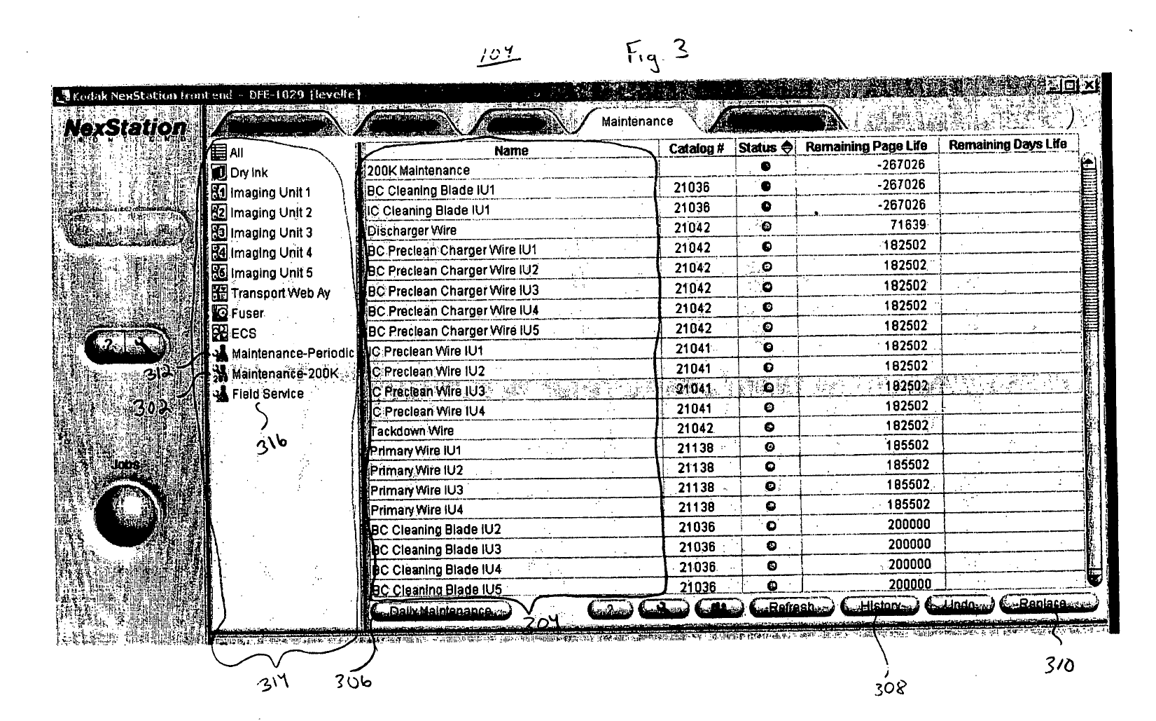

FIG. 3 illustrates a portion of the user interface 104, according to an embodiment of the present invention, that pertains to grouping ORCs by similar maintenance requirements. In the embodiment of FIG. 3, a group of ORCs 302 associated with a 200,000 page-printed maintenance service is shown. In particular, the ORCs shown in the visual representation 304 are all ORCs that need to be maintained on or about the time when 200,000 pages have been printed by the device 102. FIG. 3 also illustrates other groupings of ORCs by similar maintenance requirements with a “Maintenance-Periodic” group 312, which includes a group of ORCs that have maintenance activities that should be performed simultaneously at periodic points in time, and with a “Daily Maintenance” button 306, which, upon selection, reveals to the user maintenance tasks that must be performed on particular ORCs of the device 102 on a daily basis.

FIG. 3 also illustrates a portion of the user interface 104, according to an embodiment of the present invention, that pertains to grouping ORCs by user access level. In particular, the visual representation 314 includes an identifier 316 for a group of ORCs accessible only by a field service engineer (i.e., a trained service technician of the device 102). An operator of the user interface 104 must have a user access level associated with a field service engineer to view the identifier 316. Any of the groups of ORCs identified in the visual representation 314 that require a higher access level than that of the operator are not viewable or accessible by the operator.

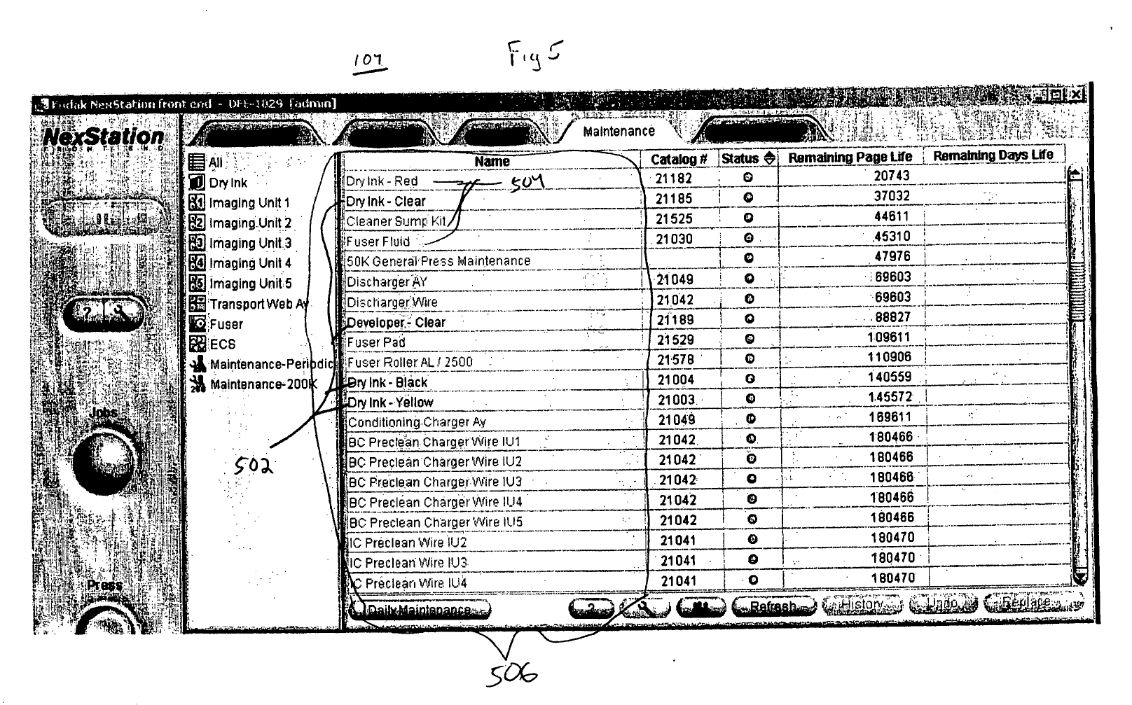

FIG. 5 illustrates another technique for grouping ORCs by user access level according to an embodiment of the present invention. In particular, if an operator has an access level that does not allow him or her to maintain all of the ORCs viewable in the visual representation 506, the inaccessible ORCs 504 are shown in gray and are not selectable by the operator. The ORCs 502 shown in solid black in FIG. 5 indicate the ORCs that the operator is allowed to access or maintain. In this embodiment, the operator is allowed to maintain only ink modules and developer modules that are currently installed in the device 102. Although the embodiment of FIG. 5 illustrates inaccessible ORCs in gray unselectable text, one skilled in the art will appreciate that other techniques for indicating that ORCs are inaccessible may be used. For example, the inaccessible ORCs may not be displayed at all to the operator via the user interface 104.

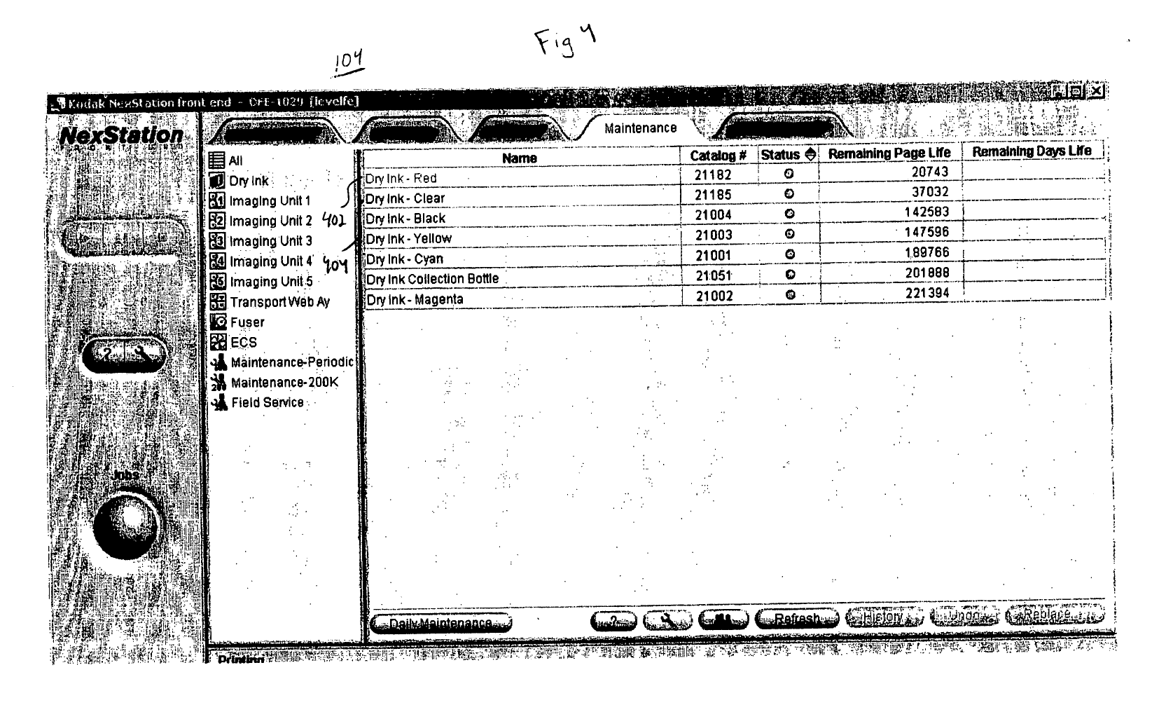

FIG. 4 illustrates a portion of the user interface 104 pertaining to swappable ORCs. In this example embodiment, a dry ink toner module associated with red toner 402, has been swapped out of the device 102. In its place, a clear toner dry ink module 404 has been inserted into the device 102. The swapped out red dry ink module 402 is shown by a first indicator. In this example, the first indicator is the name of the red dry ink module 402 shown in a predetermined color. Because the Red ink module 402 is swapped out of the device, its estimated remaining useful life does not decrease based on use of the device 102. ORCs that are currently installed in the device 102 are shown by a second indicator, in this case, the ORC name is shown in second color other than the predetermined color. One skilled in the art will appreciate, however, that any indicators illustrating that ORCs are swapped in or swapped out of the device may be used.

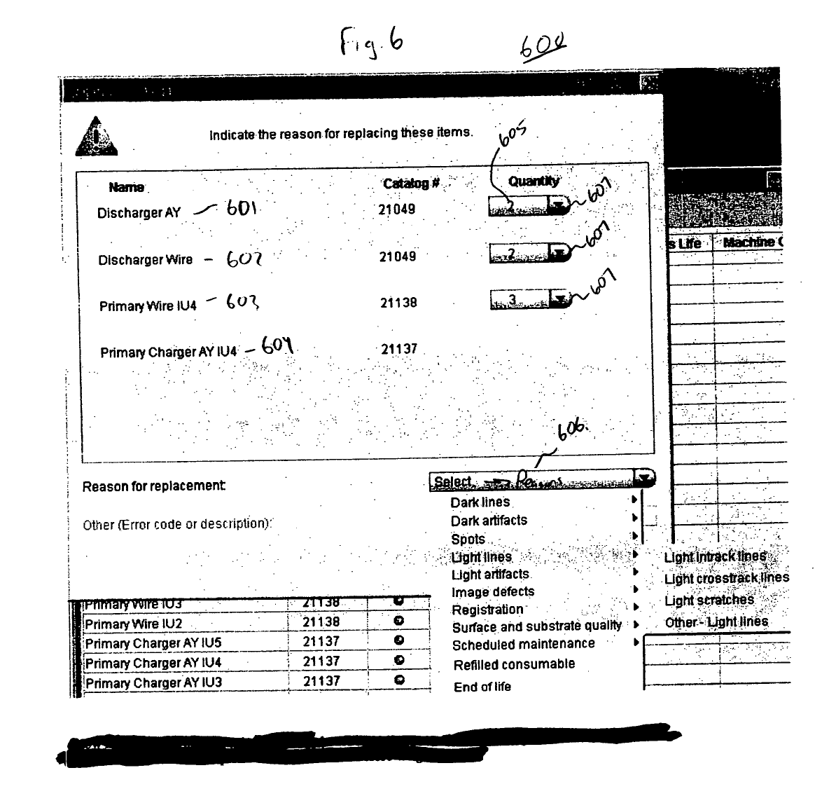

Returning to FIG. 3, when an operator would like to maintain an ORC, such user may select the ORC's name in the visual representation 304 with a selection mechanism, and then may select the replace button 310 with the selection mechanism. Upon selection of the maintain button 310, the operator is presented with a screen 600 shown in FIG. 6. If the selected ORC includes subcomponents, such as subcomponents 601-604, the operator may indicate which or all of the subparts 601-604 are being maintained in a particular maintenance procedure. If the selected ORC includes more than one subcomponent of a particular type, for example two subcomponents 605, the operator may indicate how many of the subcomponents of a particular type are being maintained via the quantity fields 607. According to an embodiment of the present invention, the operator, prior to selecting the maintain button 310, may select multiple ORCs in the visual representation 304 and then select the maintain button 310. In this instance, the screen 600 may show the subcomponents belonging to all of the ORCs selected in the visual representation 304.

Upon indicating which ORCs or subcomponents are being maintained, the user may select a particular reason for replacing the part(s) via the menu 606. Such information may be useful to a trained service technician or to a manufacturer of the device 102. Although not shown in the figures, an embodiment of the present invention also presents to an operator instructions for replacing a selected ORC and/or a selected subcomponent of an ORC, when the operator indicates that they are going to maintain such part(s).

An additional feature of the user interface 104 is the history button 308, which, upon selection, displays to the operator all of the previous ORC maintenance performed on the device 102. Such information is useful to trained service technicians as well as the manufacturer of the device 102.

It is to be understood that the exemplary embodiments are merely illustrative of the present invention and that many variations of the above-described embodiments can be devised by one skilled in the art without departing from the scope of the invention. For example, the figures included herewith illustrate a user interface with multiple visual representations shown simultaneously. However, one skilled in the art will appreciate that such visual representations may not be displayed simultaneously and may be displayed separately at different times. For example, an operator may first be presented with a visual representation similar to 202 in FIG. 2, and, upon selection of a group of ORCs in the visual representation, the operator may subsequently be presented with a visual representation similar to 204 in FIG. 2 in place of the visual representation similar to 202 in FIG. 2. Other variations in sequences of display of visual representations may be performed. In addition, although the descriptions of the embodiments of the invention contained herein often pertain to user interfaces, one skilled in the art will appreciate that computer-executable code for implementing such user interfaces and their underlying processes may be stored on one or more computer-accessible memories. Such computer-executable code may be provided to a computer to implement the user interfaces and underlying processes described herein. The generation of such computer-executable code is well within the skill level of one having ordinary skill in this art. It is therefore intended that all such variations be included within the scope of the following claims and their equivalents.

### PARTS LIST

| | |
|---|---|
| 100 | general system |
| 101 | computer system |
| 102 | device |
| 103 | data storage system |
| 104 | user interface |
| 202 | visual representation |
| 204 | visual representation |
| 206 | transport web group |
| 208 | status column |
| 210 | red indicator |
| 212 | yellow indicator |
| 214 | green indicator |
| 216 | remaining page life |
| 218 | fuser group |
| 220 | all group |
| 222 | visual representation |
| 302 | maintenance 200K group of ORCs |
| 304 | visual representation |
| 306 | maintenance button |
| 308 | history button |
| 310 | replace button |
| 314 | visual representation |
| 316 | field service group |
| 402 | Red toner |
| 502 | accessible ORCs |
| 504 | inaccessible ORCs |
| 506 | visual representation |
| 600 | screen |
| 601-604 | subcomponents |
| 605 | quantity of subcomponents |
| 606 | menu |

What is claimed is:

1. A user interface implemented as part of a computer system, the user interface configured to facilitate the management of operator replaceable components (“ORCs”) in a device, the user interface comprising:
a display system;
a first visual representation on the display system of a plurality of groups of ORCs for the device;
a selection mechanism configured to select, via the first visual representation, a selected group of ORCs from the plurality of groups of ORCs;
a second visual representation on the display system of a plurality of ORCs belonging to the selected group of ORCs; and
a third visual representation on the display system of information pertaining to the plurality of ORCs belonging to the selected group of ORCs.

2. The user interface of claim 1, wherein the first visual representation comprises a list of identifiers each associated with one of the plurality of groups of ORCs.

3. The user interface of claim 1, wherein the plurality of groups of ORCs include a group of ORCs having a similar location within the device.

4. The user interface of claim 1, wherein the plurality of groups of ORCs include a group of ORCs having similar maintenance requirements.

5. The user interface of claim 1, wherein the plurality of groups of ORCs include a group of ORCs that are economical or efficient to be maintained together.

6. The user interface of claim 1, wherein the second visual representation comprises a list of first identifiers each associated with one of a first plurality of ORCs belonging to the selected group of ORCs, wherein the first plurality of ORCs are associated with a first user access level, wherein the second visual representation further comprises one or more first indicators that indicate that the first plurality of ORCs are associated with the first user access level, wherein the second visual representation further comprises a list of second identifiers each associated with one of a second plurality of ORCs belonging to the selected group of ORCs, wherein the second plurality of ORCs are associated with a second user access level, and wherein the second visual representation further comprises one or more second indicators that indicate that the second plurality of ORCs are associated with the second user access level.

7. The user interface of claim 6, wherein the first indicator(s) comprise(s) a first color associated with the list of first identifiers, and wherein the second indicator(s) comprise(s) a second color associated with the list of second identifiers.

8. The user interface of claim 1, wherein the plurality of ORCs of the second visual representation are associated with a first user access level.

9. The user interface of claim 1, wherein the second visual representation includes a list of identifiers each associated with one of the plurality of ORCs belonging to the selected group of ORCs.

10. The user interface of claim 1, wherein the third visual representation includes estimated remaining useful life information for each of the plurality of ORCs belonging to the selected group of ORCs.

11. The user interface of claim 10, wherein the second visual representation includes a list of identifiers each associated with one of the plurality of ORCs belonging to the selected group of ORCs, and wherein the list of identifiers are sorted based at least upon the estimated remaining useful life information.

12. The user interface of claim 10, wherein the second visual representation includes a list of identifiers each associated with one of the plurality of ORCs belonging to the selected group of ORCs, and wherein the estimated remaining useful life information is displayed by the third visual representation as a color-coded symbol for each of the plurality of ORCs belonging to the selected group of ORCs.

13. The user interface of claim 12, wherein the color-coded symbol for each of the plurality of ORCs belonging to the selected group of ORCs is a red-colored symbol, a yellow-colored symbol, or a green-colored symbol, wherein the red-colored symbol identifies an ORC having no estimated remaining useful life, wherein the yellow-colored symbol identifies an ORC having little estimated remaining useful life, and wherein the green-colored symbol identifies an ORC having substantial estimated remaining useful life.

14. The user interface of claim 1, wherein the first visual representation, the second visual representation, and the third visual representation are displayed on the display system simultaneously.

15. The user interface of claim 1, wherein the selection mechanism is further configured to select, via the second visual representation or the third visual representation, a selected ORC from the plurality of ORCs belonging to the selected group of ORCs, and wherein the user interface further comprises a fourth visual representation. on the display system of a plurality of sub-components belonging to the selected ORC.

16. The user interface of claim 1, wherein the selection mechanism is further configured to select, via the second visual representation or the third visual representation, a selected ORC from the plurality of ORCs belonging to the selected group of ORCs, and wherein the user interface further comprises a fourth visual representation facilitating the provision of instructions regarding replacing the selected ORC or subcomponents thereof.

17. The user interface of claim 1, wherein the selection mechanism is further configured to select, via the second or third visual representation, a selected ORC from the plurality of ORCs belonging to the selected group of ORCs, and wherein the user interface further comprises a fourth visual representation facilitating the receipt of information from a user regarding one or more reasons that the selected ORC, or sub-components thereof, is or are being maintained.

18. The user interface of claim 1, wherein the second visual representation includes a first visual sub-representation of a plurality of ORCs belonging to the selected group of ORCs that are currently installed in the device and a second visual sub-representation, different from the first visual sub-representation of a plurality of ORCs belonging to the selected group of ORCs that are not currently installed in the device.

19. One or more computer-accessible memories storing computer code for implementing a user interface configured to facilitate the management of operator replaceable components (“ORCs”) in a device, wherein the computer code comprises:
code for displaying a first visual representation on a display system of a plurality of groups of ORCs for the device;
code for processing a selection via the first visual representation of a selected group of ORCs from the plurality of groups of ORCs;
code for displaying a second visual representation on the display system of a plurality of ORCs belonging to the selected group of ORCs; and
code for displaying a third visual representation on the display system of information pertaining to the plurality of ORCs belonging to the selected group of ORCs.

20. The one or more computer-accessible memories of claim 19, wherein the first visual representation comprises a list of identifiers each associated with one of the plurality of groups of ORCs.

21. The one or more computer-accessible memories of claim 19, wherein the plurality of groups of ORCs include a group of ORCs having a similar location within the device.

22. The one or more computer-accessible memories of claim 19, wherein the plurality of groups of ORCs include a group of ORCs having similar maintenance requirements.

23. The one or more computer-accessible memories of claim 20, wherein the plurality of groups of ORCs include a group of ORCs that are economical or efficient to be maintained together.

24. The one or more computer-accessible memories of claim 19, wherein the second visual representation comprises a list of first identifiers each associated with one of a first plurality of ORCs belonging to the selected group of ORCs, wherein the first plurality of ORCs are associated with a first user access level, wherein the second visual representation further comprises one or more first indicators that indicate that the first plurality of ORCs are associated with the first user access level, wherein the second visual representation further comprises a list of second identifiers each associated with one of a second plurality of ORCs belonging to the selected group of ORCs, wherein the second plurality of ORCs are associated with a second user access level, and wherein the second visual representation further comprises one or more second indicators that indicate that the second plurality of ORCs are associated with the second user access level.

25. The one or more computer-accessible memories of claim 24, wherein the first indicators comprise a first color associated with the list of first identifiers, and wherein the second indicators comprise a second color associated with the list of second identifiers.

26. The one or more computer-accessible memories of claim 19, wherein the plurality of ORCs of the second visual representation are associated with a first user access level.

27. The one or more computer-accessible memories of claim 19, wherein the second visual representation includes a list of identifiers each associated with one of the plurality of ORCs belonging to the selected group of ORCs.

28. The one or more computer-accessible memories of claim 19, wherein the third visual representation includes estimated remaining useful life information for each of the plurality of ORCs belonging to the selected group of ORCs, and wherein the second visual representation includes a list of identifiers each associated with one of the plurality of ORCs belonging to the selected group of ORCs, and wherein the list of identifiers are sorted based at least upon the estimated remaining useful life information.

29. The one or more computer-accessible memories of claim 28, wherein the estimated remaining useful life information is displayed by the third visual representation as a color-coded symbol for each of the plurality of ORCs belonging to the selected group of ORCs.

30. The one or more computer-accessible memories of claim 19, wherein the selection mechanism is further configured to select, via the second visual representation or the third visual representation, a selected ORC from the plurality of ORCs belonging to the selected group of ORCs, and wherein the computer code further comprises code for displaying a fourth visual representation on the display system of a plurality of sub-components belonging to the selected ORC.

31. The one or more computer-accessible memories of claim 19, wherein the selection mechanism is further configured to select, via the second visual representation or the third visual representation, a selected ORC from the plurality of ORCs belonging to the selected group of ORCs, and wherein the computer code further comprises code for displaying a fourth visual representation facilitating the provision of instructions regarding replacing the selected ORC or subcomponents thereof.
